(19) United States
(12) Patent Application Publication
(10) Pub. No.: US 2020/0376639 A1
(43) Pub. Date: Dec. 3, 2020

(54) MULTIPLE STRIKE FASTENER DRIVER/HOLDER

(71) Applicant: Klein Tools, Inc., Lincolnshire, IL (US)

(72) Inventors: Scott M. Hargis, North Brook, IL (US); John H. Kargenian, Prospects Heights, IL (US)

(73) Assignee: Klein Tools, Inc., Lincolnshire, IL (US)

(21) Appl. No.: 16/426,131

(22) Filed: May 30, 2019

(51) Int. Cl. B25C 1/02; B25C 5/11; B25C 5/16; B25C 1/00

(52) U.S. Cl. CPC B25C 1/02; B25C 1/001; B25C 5/1606; B25C 5/11

(57) ABSTRACT

A multiple strike fastener driver/holder is provided and includes a fastener drive assembly, a catch, and a feeder assembly. The drive assembly includes an anvil mounted in a frame to translate in an impact direction to drive a fastener into a work surface and to translate an opposite direction to allow another fastener to be positioned for driving into a work surface. The feeder assembly is configured to carry a plurality of fasteners and to sequentially position each fastener of the plurality of fasteners relative to the fastener drive assembly to be driven into a work surface. The catch includes a catch tab having a pair of spaced surfaces that engage an elongate shaft of the anvil with the catch in the first condition to restrict translation of the anvil in the opposite direction.

### CROSS-REFERENCE TO RELATED APPLICATIONS

None

### BACKGROUND OF THE DISCLOSURE

The present disclosure relates to devices for driving a fastener, such as a nail or staple, into a workpiece, and more particularly, to such devices that can carry a plurality of fasteners and sequentially feed the fasteners so that each fastener can be driven into a workpiece via multiple strikes of the device with a manual impact tool, such as a mallet or hammer. Known devices employ an anvil that transfers the impact force from a mallet or hammer to a fastener to drive the fastener into a workpiece. To accommodate multiple strikes from the mallet or hammer while maintaining the anvil in a “driven” position after each strike, known devices employ relatively complex mechanisms, typically ratchet mechanisms that engage a rack with a pawl, to hold the anvil in its “driven” position after each strike, with the pawl being released after the fastener is driven to a desired depth into the workpiece. While many such devices are known and perform successfully for their intended purpose, there is always a desire for improvement. For example, there is always a desire to improve one or more of the simplicity, reliability, maintainability, and/or cost of manufacture of such devices.

### BRIEF SUMMARY OF THE DISCLOSURE

In accordance with one feature of this disclosure, a multi-strike fastener driver/holder is provided and includes a fastener drive assembly and a feeder assembly. The fastener drive assembly includes a frame and an anvil mounted in the frame to translate along a drive axis in an impact direction to drive a fastener into a work surface and to translate along the drive axis in an opposite direction to allow another fastener to be positioned for driving into a work surface. The anvil includes an elongate shaft. The drive assembly further includes a catch mounted in the frame to be actuated between a first condition and a second condition. In the first condition, the catch allows translation of the anvil in the impact direction and restricts translation of the anvil in the opposite direction. In the second condition, the catch allows translation of the anvil in the opposite direction. The catch includes a catch tab having a pair of spaced surfaces that engage the elongate shaft with the catch in the first condition to restrict translation of the anvil in the opposite direction. The feeder assembly is fixed to the frame and is configured to carry a plurality of fasteners and to sequentially position each fastener of the plurality of fasteners relative to the fastener drive assembly to be driven by the fastener drive assembly into a work surface.

As one feature, the spaced surfaces define at least a portion of an opening, and the elongate shaft extends through the opening. In a further feature, a length of the shaft has a uniform transverse cross-section. As yet a further feature, the transverse cross-section has a polygonal shape, the opening has a matching polygonal shape, and the surfaces define two sides of the polygonal shape of the opening. In a further feature, the polygonal shapes are octagonal and the surfaces define opposite sides of the octagonal shape of the opening. As another feature, each of the surfaces includes an edge that engages the shaft, the tab has a thickness at the opening, and the edges are spaced by the thickness.

According to one feature, the spaced surfaces engage opposite sides of the shaft with the catch in the first condition. In a further feature, each of the surfaces includes an edge that engages the shaft.

In one feature, the catch tab is mounted in the frame to pivot between a first position wherein the catch is in the first condition and a second position wherein the catch is in the second condition. As a further feature, the catch tab has an end portion located between the shaft and the frame, and the frame has a slot that receives the end portion.

As one feature, the catch further includes at least one bias spring extending between the frame and the catch tab to bias the catch tab toward the first position.

In one feature, the catch tab can pivot from the first position toward the second position as the anvil translates in the impact direction.

According to one feature, the shaft includes a distal end located to be impacted by a manually operated impact tool, and the catch tab includes a surface located to be selectively engaged by a user to manually actuate the catch tab to the second position.

In one feature, the drive assembly further includes a return spring positioned between the frame and the anvil to bias the anvil in the opposite direction. In a further feature, the return spring is an elongate helical spring and the shaft has an elongate bore that receives a portion of the return spring. In yet a further feature, the frame includes a spring guide received within a portion of the return spring.

As one feature, the feeder assembly includes a fastener magazine configured to carry the plurality of fasteners, and a fastening nozzle configured to sequentially receive individual fasteners from the fastener magazine and to sequentially position each fastener relative to the fastener drive assembly to be driven into a work surface by the fastener drive assembly. In a further feature, the anvil includes a drive surface configured to strike a fastener positioned in the fastening nozzle to drive the fastener into a work surface, and the anvil is trapped between a portion of the frame and a portion of the fastening nozzle.

### BRIEF SUMMARY OF THE SEVERAL VIEWS OF THE DRAWINGS

FIG. 1 is a longitudinal, central cross-section of a multiple strike fastener driver/holder according to this disclosure, and further showing a manual impact tool for striking the driver/holder, a workpiece into which fasteners are to be driven, and a cylindrical component, partially broken away, carried on a surface of the workpiece and over which fasteners are to be driven;

FIG. 2 is a perspective view from the front and above of the fastener driver/holder of FIG. 1;

FIG. 3 is a perspective view from the rear and above of the fastener driver/holder of FIG. 1;

FIG. 4A is a partial, longitudinal, central cross-section similar to FIG. 1 showing an anvil component of the fastener holder/driver and a first fastener in a loading position prior to the anvil component being struck by a manual impact tool;

FIG. 4B is a view similar to FIG. 4A, but showing the anvil component and the first fastener in a driven position after the anvil component has been struck by a manual impact tool;

FIG. 4C is a view similar to FIGS. 4A and 4B, but showing the anvil component and the first fastener in a further driven position after the anvil component has been struck again by the manual impact tool;

FIG. 4D is a view similar to FIGS. 4A-4C, but showing the anvil component and another fastener in the loading position after the first fastener has been driven to a desired depth into the workpiece and the anvil component has been returned to the loading position;

FIG. 5 is an enlarged, partial section view taken from line 5-5 in FIG. 1;

FIG. 6 is a partial section view taken from line 6-6 in FIG. 5 and showing a catch component of the fastener driver/holder in a first condition;

FIG. 7 is a view similar to FIG. 6, but showing the catch component in a second condition;

FIG. 8 is a perspective view from the rear and above of the anvil component of the fastener driver/holder of FIGS. 1-7

FIG. 9 is a perspective view from the front and below of the anvil component;

FIG. 10 a rear elevation view of the anvil component;

FIG. 11 is a left side elevation view of the anvil component;

FIG. 12 is a perspective view from the front and above of a catch component of the fastener driver/holder of FIGS. 1-7;

FIG. 13 is a perspective view from the rear and above of the catch component of FIG. 12;

FIG. 14 is an enlarged, partial section view taken from line 14-14 in FIG. 1;

FIG. 15 is a section view taken from line 15-15 in FIG. 14;

FIG. 16 is a section view taken from line 16-16 in FIG. 14;

FIG. 17 is a rear elevation view of a frame component, a spring, and a spring guide of the fastener driver/holder of FIGS. 1-7; and

FIG. 18 is a front elevation view of another frame component of the fastener driver/holder of FIGS. 1-7.

### DETAILED DESCRIPTION OF PREFERRED EMBODIMENTS

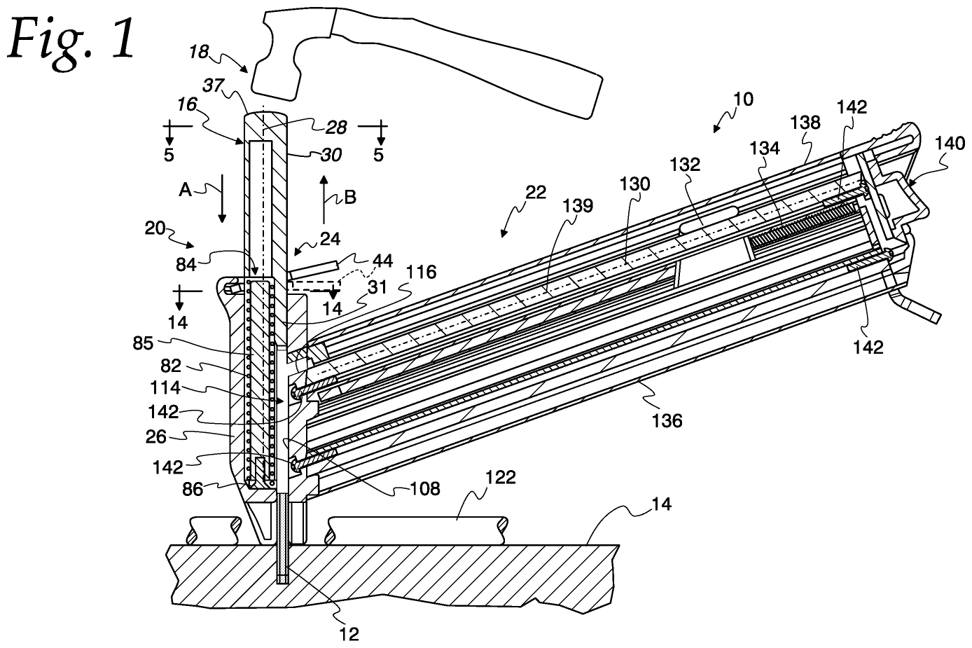

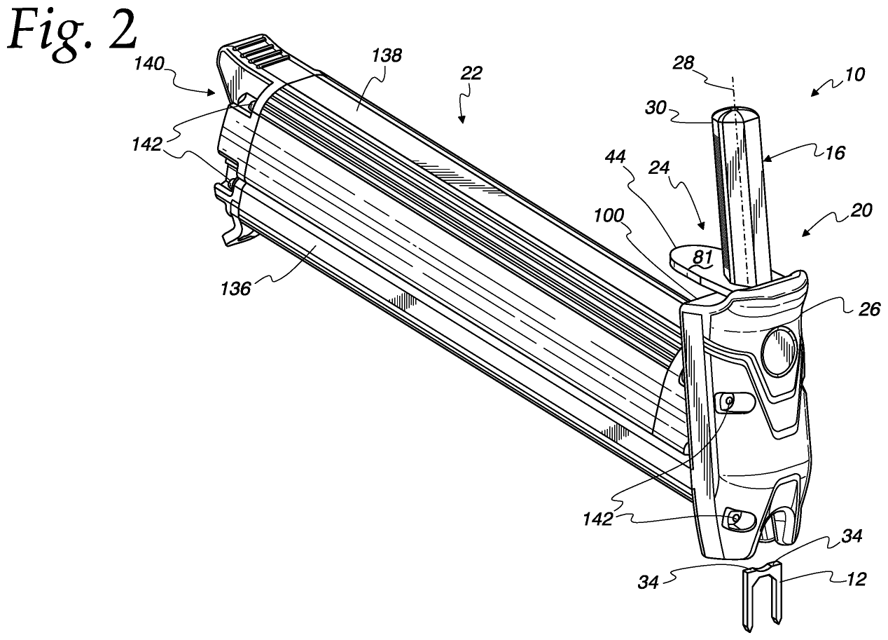

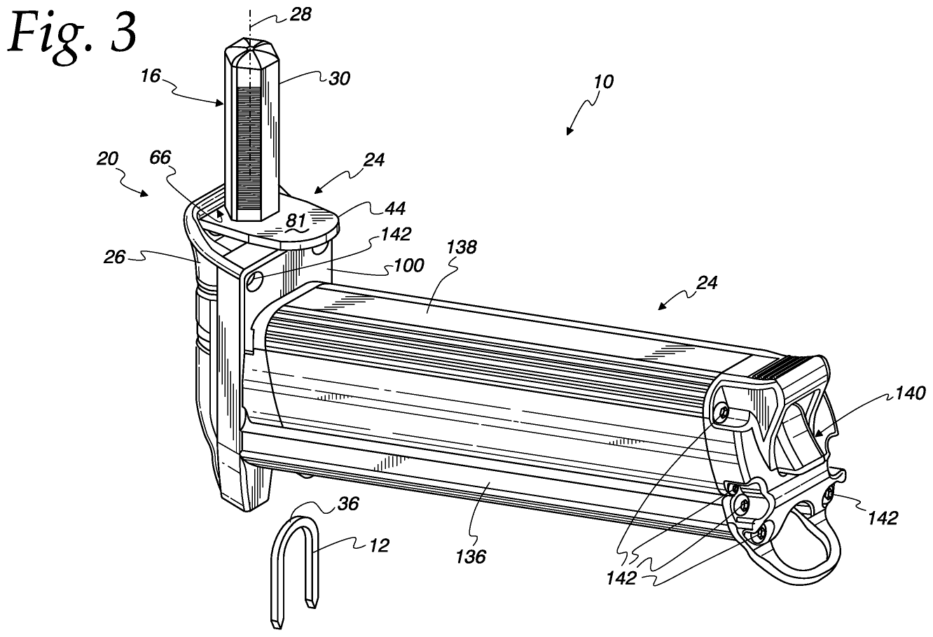

As best seen in FIGS. 1-3, a fastening device 10 is provided in the form of a multi-strike fastener driver/holder 10 that holds a plurality of fasteners 12 and allows a user to drive each of the fasteners 12 into a workpiece 14 (see FIG. 3) by striking an anvil 16 of the driver/holder 10 multiple time with a manually operated impact tool 18, such as a mallet or hammer 18. The driver/holder 10 includes a fastener drive assembly 20 that mounts the anvil 16 and a fastener feeder assembly 22 that carries the plurality of fasteners 12 and sequentially positions each fastener 12 relative to the fastener drive assembly 20 to be driven by the fastener drive assembly 20 into a workpiece 14. As best seen in FIGS. 2 and 3, the fasteners 12 are shown in the form of u-shaped staples 12, but it should be understood that the inventive features disclosed herein for the driver/holder 10 can be utilized with any type or configuration of fastener that is intended to be driven into a workpiece, such as, for example, nails or tacks.

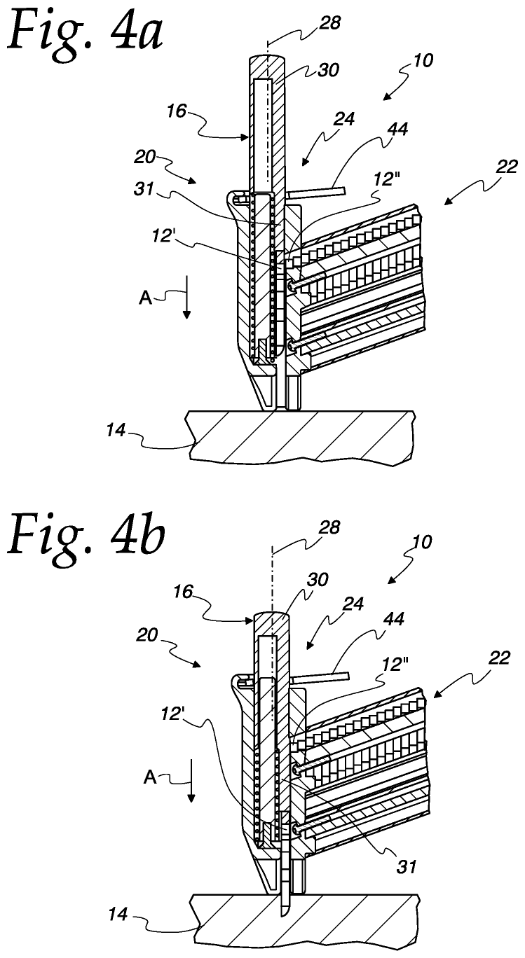

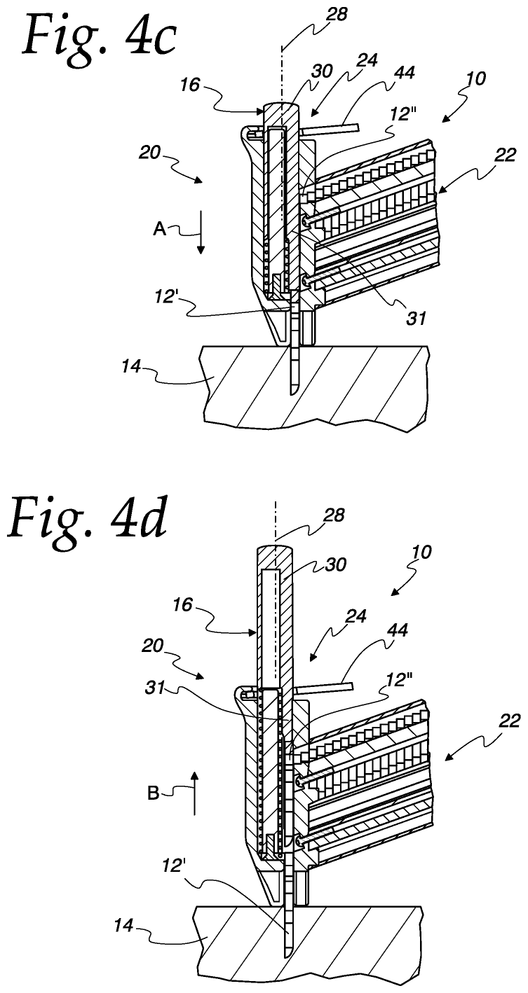

As best seen by the sequence illustrated in FIGS. 4A-D, the anvil 16 and a fastener 12′ are displaced relative to the remainder of the driver/holder 10 with each strike by the tool 18, with the anvil 16 being held in its displaced location by a catch 24 after each strike until the user is satisfied that the fastener 12′ has been driven to a desired depth into the workpiece 14 and manually releases the catch 24 to allow the anvil 16 to return to a loading position (shown in FIGS. 4A and 4) that allows the feeder assembly 22 to automatically load another fastener 12″ into a ready position where it can be driven into the workpiece 14. In this regard, FIG. 4A shows the anvil 16 and the fastener 12′ in the loading position before the anvil 16 has been struck by the tool 18. FIG. 4B shows the anvil 16 and the fastener 12′ in a first driven position after the anvil has been struck by the tool 18, with the fastener 12′ partially driven into the workpiece 14. FIG. 4C shows the anvil 16 and the fastener 12′ in a second driven position after than anvil has been struck again by the tool 18, with the fastener 12′ driven to a desired depth into the workpiece 14. FIG. 4D shows the anvil 16 and another fastener 12″ in the loading position after the catch 24 has been manually released by a user to allow the anvil 16 to return to the loading position, with the fastener 12′ remaining in the workpiece 14.

As best seen in FIGS. 1-3, the fastener drive assembly 20 includes a rigid frame 26, with the anvil 16 mounted in the frame 26 to translate along a drive axis 28 in an impact direction, shown by arrow A in FIG. 1, to drive a fastener 12 into a workpiece 14 and to translate along the drive axis 28 in an opposite direction, shown by arrow B in FIG. 1, to allow the anvil 16 to return to the loading position to allow another fastener 12 to be position for driving into the workpiece 14. The catch 24 is mounted to the frame 26 to be actuated between a first condition (shown in FIGS. 1-6) and a second condition (shown in FIG. 7 and by phantom lines in Fig.1). In the first condition, the catch 24 allows translation of the anvil 16 in the impact direction and restricts translation of the anvil 16 in the opposite direction. In the second condition, the catch 24 allows translation of the anvil 16 in the opposite direction.

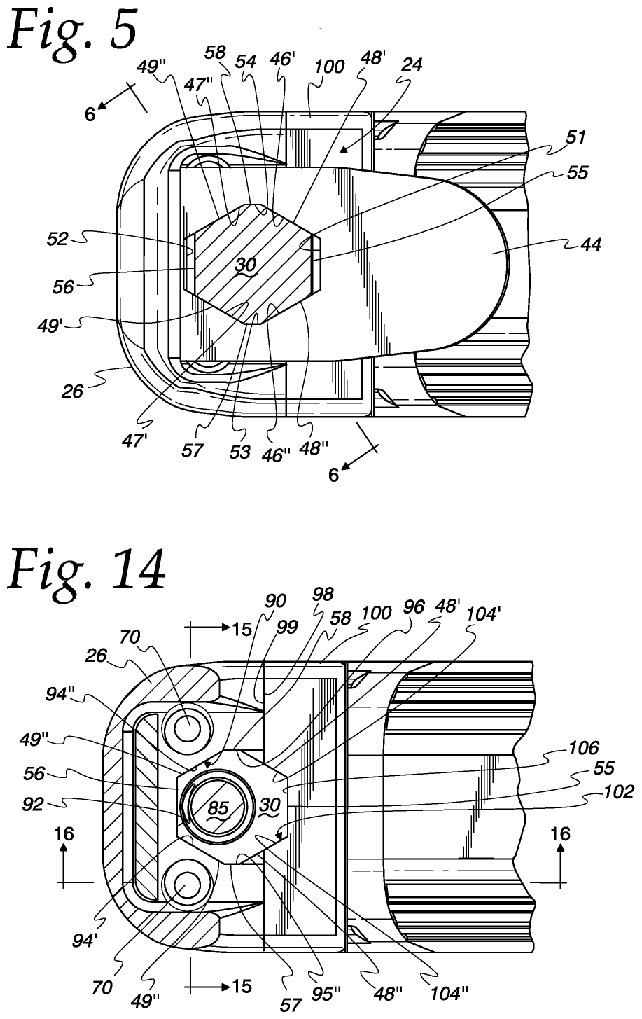

As best seen in FIGS. 8-11, the anvil 16 includes an elongate shaft 30 and a fastener impact portion 31. The fastener impact portion 31 includes an impact surface 32 configured to impact the fasteners 12 to drive each fastener 12 into a workpiece. In this regard, the surface 32 is preferably shaped to conform at least partially to an impact surface on each fastener 12, with the surface 32 in the illustrated embodiment having a pair of planar portions 33 to impact the surfaces 34 on the configuration of the fastener 12 shown in FIG. 2, and a concave surface 35 that conforms to a convex impact surface 36 on the configuration of the fastener 12 shown in FIG. 3. The shaft 30 has a distal end 37 that is located to be impacted by the tool 18. The impact portion 31 further includes a front face 38 with a tapered portion 39, two laterally spaced side surfaces 40 extending parallel to each other and to the axis 28, a pair of rear surfaces 41, and a pair of upwardly angled surfaces 42. A longitudinal length L of the shaft 30 extending parallel to the axis 28 has a uniform transverse cross-section, which in the embodiment of FIGS. 5-7 is an octagonal shape, but which can be any suitable shape, including any other polygonal shape, circular, semi-circular, or a combination thereof. In the illustrated embodiment, the shaft 30 and fastener impact portion 31 are formed as a single, unitary piece (i.e., formed from a single piece of material), preferably from a forged and hardened steel.

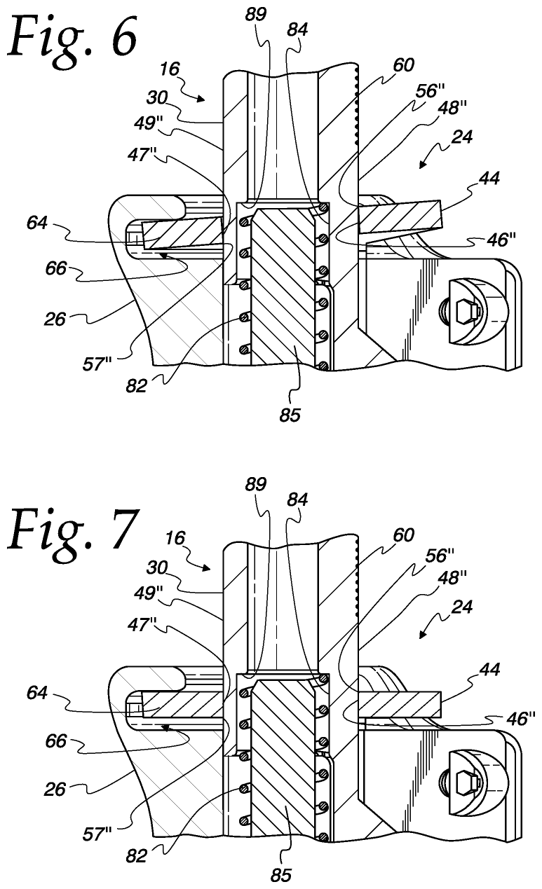

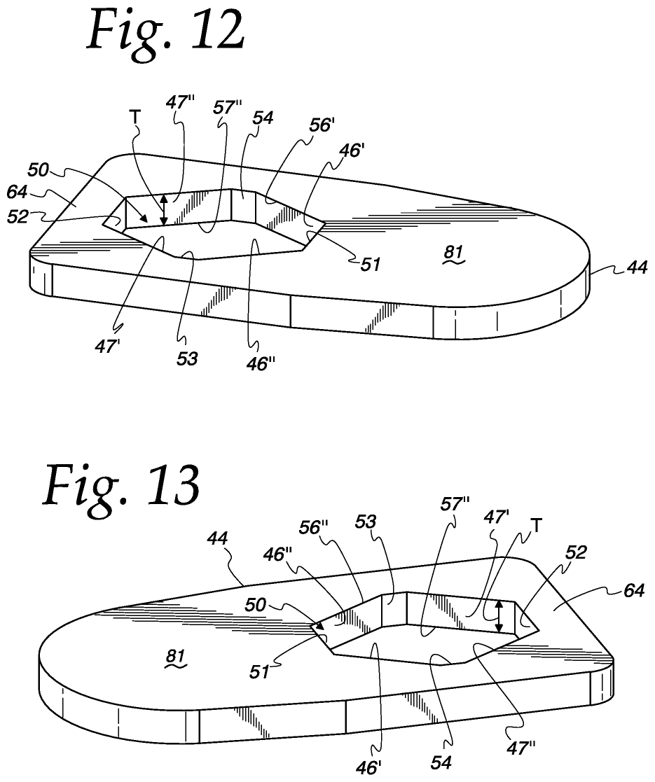

As best seen in FIG. 5, the catch 24 includes a catch tab 44 having at least a pair of spaced surfaces 46 and 47 that engage corresponding surfaces 48 and 49 on the shaft 30 in the first condition to restrict translation of the anvil 16 in the opposite direction. In the illustrated embodiments and as best seen in FIGS. 6 and 7, the surfaces 46 and 47 define at least a portion of on opening 50 formed in the tab 44, with the opening 50 of the illustrated embodiments being octagonal in shape to match the octagonal shape of the length L of the shaft 30. In the illustrated embodiment, the octagonal shape of the opening 50 includes two sets of the spaced surfaces 46 and 47, with one set identified as 46′ and 47′, and the other set identified as 46″ and 47″, which engage spaced surfaces 48′, 49′ and 48″, 49″, respectively, on the shaft 30. In the illustrated embodiment, the opening 50 is further defined by a pair of spaced surfaces 51 and 52 and another pair of spaced surfaces 53 and 54 that are located so as not to engage corresponding surfaces 55, 56, 57, and 58 on the shaft 30. As best seen in FIGS. 6, 12, and 13, each of the surfaces 46′, 47′, 46″, and 47″ includes an edge 56′, 58′, 56″, and 58″, respectively, that engages the shaft 30 with the catch 24 in the first condition. The edges 56′ and 56″ are spaced from the edges 58′ and 58″ by a thickness of T of the catch tab 44. In the illustrated embodiment, the tab 44 is flat with a uniform thickness and is preferably made from a suitable steel.

As best seen in FIG. 10, in the illustrated embodiment, the surfaces 48′ and 48″ that are engaged by the edges 56′ and 56″ of the surfaces 46′ and 46″ include serrations or teeth 60 that aid in the engagement. While the serrations/teeth 60 can be helpful in restricting translation in the opposite direction when the catch 24 is in the first condition, the serrations/teeth 60 are not required for the catch 24 to perform its intended function.

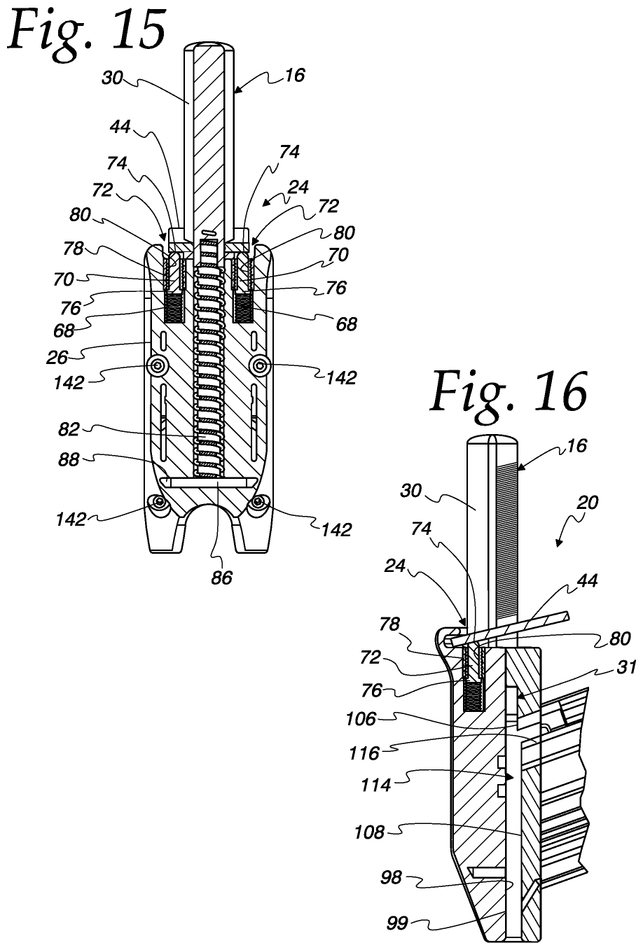

As best seen in FIGS. 6 and 7, the catch tab 44 is mounted in the frame 26 to pivot between a first position (shown in FIG. 6) where the catch 24 is in the first condition and a second position (shown in FIG. 7) where the catch 24 is in the second condition. In this regard, the catch tab 44 has an end portion 64 located between the shaft 30 and the frame 26, and the frame 26 has a slot 66 that receives the end portion 64. As best seen in FIGS. 15 and 16, the catch 24 of the illustrated embodiment further includes a pair of helical compression springs 68 extending between the frame 26 and the catch tab 44 to bias the catch tab 44 to toward the first position. In the illustrated embodiment, the catch 24 further includes a pair of cylindrical posts 70 that transfer the bias force from the springs 68 to the catch tab 44, with the springs 68 and posts 70 received for guided translation in bores 72 formed in the frame 26. Each of the posts 70 includes a semi-spherical shaped end 74 that engages against the catch tab 44 and an enlarged cylindrical end 76 that engages against the corresponding spring 68. A threaded insert 78 has a threaded engagement with the upper end of each of the bores 72 to trap each spring 68 and post 70 in the corresponding bore 72. Each insert 78 includes a through bore 80 sized to provided guided translation of the corresponding post 70. The catch tab 44 can pivot from the first position toward the second position as the anvil 16 is translated in the impact direction with each strike by tool 18. In this regard, the angular displacement of the tab 44 will be that caused by the sliding friction between the shaft 30 and the surfaces 46 and 47 of the catch tab 44 as the shaft 30 moves in the impact direction. The catch tab 44 includes a surface 81 that can be engaged by a user's fingers or thumb to manually actuate the catch tab from the first position to the second position.

As best seen in FIG. 1, the driver/holder 10 further includes a return spring 82 positioned between the anvil 16 and the frame 26 to bias the anvil 16 in the opposite direction along the drive axis 28. In the illustrated embodiment, the spring 82 is a helical compression spring, the anvil 16 has an elongate bore 84 that receives a portion of the spring 82, and the frame 26 includes an elongate, cylindrical spring guide 85 that extends centrally through the spring 82. A base plate 86 mounts the spring guide 85 into a slot 88 formed in the frame 26. As best seen in FIGS. 6 and 7, the bore 84 includes an annular shoulder 89 that engages an end of the spring 82.

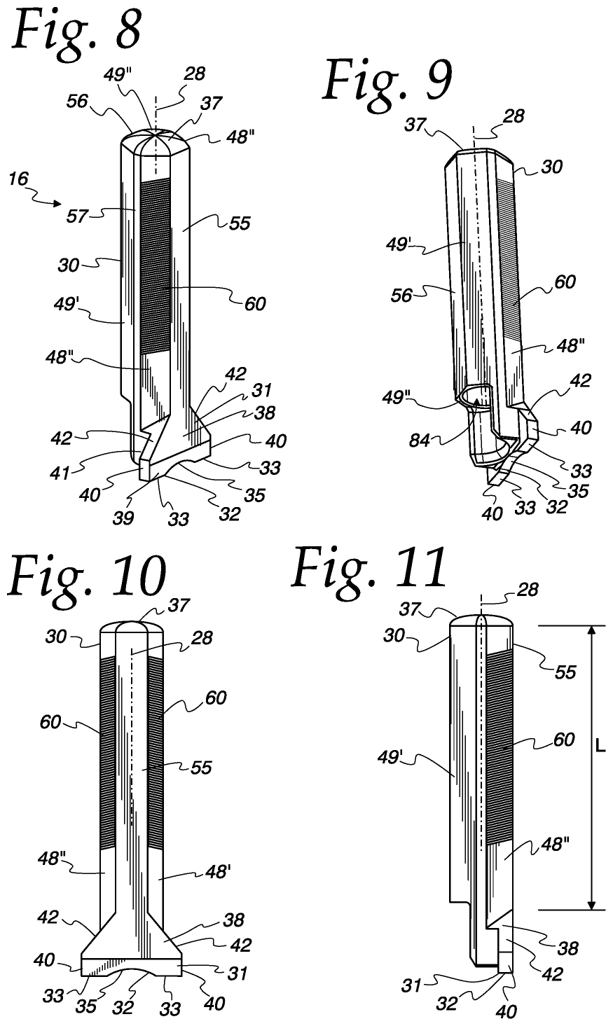

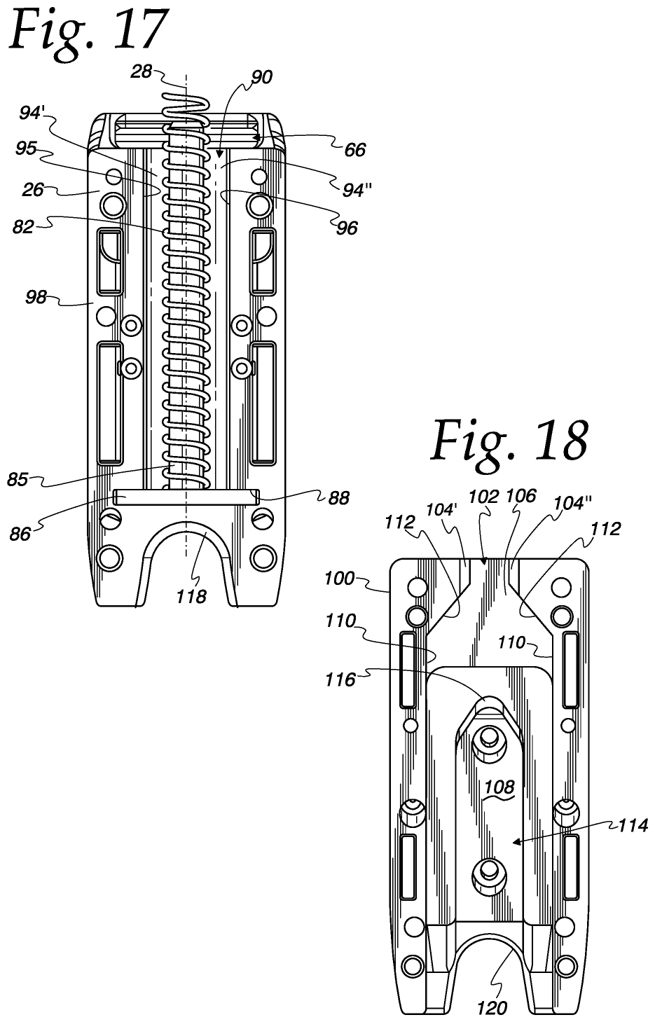

As best seen in FIGS. 14 and 17, the frame 26 includes a guide channel 90 extending along the axis 28 to receive a front portion of the anvil 16 for guided translation along the axis 28. In this regard, the channel 90 of the illustrated embodiment is shaped to conform to the portion of the octagonal cross-sectional profile of the shaft 30 that is received in the channel 90, with planar surfaces 92, 94′, 94″, 95 and 96 that oppose surfaces 56, 49′, 49″, 57 and 58, respectively, of the shaft 30. The frame 26 includes a planar face surface 98 that mates with a planar face surface 99 on a rigid frame member 100 of the fastener feeder assembly 22. As best seen in FIGS. 14 and 18, the frame member 100 of the fastener feeder assembly 22 includes a guide channel 102 that receives a back portion of the anvil 16 for guided translation along the axis 28. As best seen in FIG. 18, an upper most portion of the channel 102 includes planar surfaces 104′ and 104″ that oppose surfaces 48′ and 48″, respectively, of the shaft 30. The channel includes surfaces 106 and 108 that oppose the surface 55 of the shaft 30 and the face 38 of the fastener impact portion 31, which in the illustrated embodiment are co-planar, as best seen in FIGS. 8 and 11. The channel 102 further includes planar, lateral surfaces 110 that oppose the lateral surfaces 40 of the fastener impact portion 31. Planar surfaces 112 of the channel 102 engage the surfaces 42 of the portion 31 with the anvil 16 in the loading position to limit the movement of the anvil 16 in the opposite direction. A fastening nozzle 114 is defined by the surface 108 together with the surfaces 110 as they extend to the bottom of the frame member 26, with the face surface 98 of the frame 26 serving to close the nozzle 114 on its front side. A contoured ramp surface 116 guides the fasteners 12 into the nozzle 114. The frame 26 and the frame member 100 include u-shaped surfaces 118 and 120, respectively, that allows the nozzle 114 to be placed over a conduit, wire, or other component 122 that rests on the workpiece 14.

The fastener magazine 22 can be of any suitable construction, many of which are known, for the particular type of fastener that is to be driven by the fastening device 10, and in the illustrated embodiment shown in FIG. 1 includes an elongate, rigid fastener guide track 130, a fastener plunger 132, and at least one plunger spring 134 that biases the plunger 132 against the stack of fasteners 12 guided by the track 130 and forces each fastener 12 into the nozzle 114. The magazine 22 of the illustrated embodiment further includes a rigid lower housing member 136 and a rigid upper housing member 138 that is mounted to translate on the lower housing member 136 along a guide track axis 139 to selectively expose the guide track 130 for loading a stack of fasteners 12 onto the guide track 130. A releasable lock unit 140 is provided to selectively prevent the housing member 138 from translating relative to the housing member 136. During operation, a user grasps the housing members 136 and 138 with one hand to hold and position the device 10 while striking the anvil 16 with the tool 18. The frame 26 and the various components of the magazine 22 are joined together using suitable threaded fasteners, indicated generally at 142 in the figures. It should be understood that the specific features of the magazine 22 described in this paragraph are not critical to the inventive features/concepts described herein and that any suitable construction can be utilized with those features/concepts.

Preferred embodiments of the inventive features/concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the fastening device 10 are shown in the figures, it should be understood that this disclosure anticipates variations in the specific details of each of the disclosed components and features of the fastening device 10 and that no limitation to a specific form, configuration, or detail is intended unless expressly and specifically recited in an appended claim.

For example, while specific and preferred forms have been shown for the frame 26 and the frame member 100, in some embodiments it may be desirable in some applications for one or more feature contained in the frame member 100 to be provided in a separate component of the frame 26 rather than as part of the magazine 22. Furthermore, while each of the frame 26 and frame member 100 has been shown as a unitary part formed from one single piece of material, it may be desirable in some applications for either, or both, of the frame 26 and frame member 100 to be formed from multiple components that are assembled together.

As a further example, while the anvil 16 as been shown as a single, unitary part formed from a single piece of material, in some applications it may be desirable for the anvil 16 to be formed from multiple components that are assembled together, such as, for example, forming the shaft 30 and the fastener impact portion 31 as separate components that are joined together to form the anvil 16.

A yet a further example, while a particular shape and geometry have been shown for the catch tab 44, other shapes and geometries may be desirable depending upon the requirements of each application. Further in this regard, while octagonal shapes have been shown for opening 50 and the transverse cross section of the shaft 30, other shapes and geometries are contemplated including circular, semi-circular and other polygonal shapes, with the opposite sides 46 and 47 of the catch tab 44 being configured to engage such alternative shapes.

In another example, while a pair of helical compression springs 68 have been disclosed herein for use in the catch 24, a single spring or more than two springs and/or different types of springs, such a leaf springs, may be desired.

As one example, while the pivot mounting of the tab 44 is provided by the engagement of the end portion 64 in the slot 66, other types of pivot mountings may be desirable depending upon the particulars of an application.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. A multi-strike fastener driver/holder comprising:
a fastener drive assembly comprising:
a frame;
an anvil mounted in the frame to translate along a drive axis in an impact direction to drive a fastener into a work surface and to translate along the drive axis in an opposite direction to allow another fastener to be positioned for driving into a work surface, the anvil comprising an elongate shaft; and
a catch mounted in the frame to be actuated between a first condition and a second condition, in the first condition the catch allows translation of the anvil in the impact direction and restricts translation of the anvil in the opposite direction, in the second condition the catch allows translation of the anvil in the opposite direction, the catch comprising a catch tab having a pair of spaced surfaces that engage the elongate shaft with the catch in the first condition to restrict translation of the anvil in the opposite direction; and
a feeder assembly fixed to the frame, the feeder assembly configured to carry a plurality of fasteners and to sequentially position each fastener of the plurality of fasteners relative to the fastener drive assembly to be driven by the fastener drive assembly into a work surface.

2. The multi-strike fastener driver/holder of claim 1 wherein the spaced surfaces define at least a portion of an opening, and the elongate shaft extends through the opening.

3. The multi-strike fastener driver/holder of claims 2 wherein a length of the shaft has a uniform transverse cross-section.

4. The multi-strike fastener driver/holder of claim 3 wherein the transverse cross-section has a polygonal shape, the opening has a matching polygonal shape, and the surfaces define two sides of the polygonal shape of the opening.

5. The multi-strike fastener driver/holder of claim 4 wherein the polygonal shapes are octagonal and the surfaces define opposite sides of the octagonal shape of the opening.

6. The multi-strike fastener driver/holder of claim 4 wherein each of the surfaces comprises an edge that engages the shaft, the tab has a thickness at the opening, and the edges are spaced by the thickness.

7. The multi-strike fastener driver/holder of claim 1 wherein the spaced surfaces engage opposite sides of the shaft with the catch in the first condition.

8. The multi-strike fastener driver/holder of claim 7 wherein each of the surfaces comprises an edge that engages the shaft.

9. The multi-strike fastener driver/holder of claim 1 wherein the catch tab is mounted in the frame to pivot between a first position wherein the catch is in the first condition and a second position wherein the catch is in the second condition.

10. The multi-strike fastener driver/holder of claim 9 wherein the catch tab has an end portion located between the shaft and the frame, and the frame has a slot that receives the end portion.

11. The multi-strike fastener driver/holder of claim 9 wherein the catch further comprises at least one bias spring extending between the frame and the catch tab to bias the catch tab toward the first position.

12. The multi-strike fastener driver/holder of claim 11 wherein the catch tab can pivot from the first position toward the second position as the anvil translates in the impact direction.

13. The multi-strike fastener driver/holder of claim 11 wherein the shaft includes a distal end located to be impacted by a manually operated impact tool, and the catch tab includes a surface located to be selectively engaged by a user to manually actuate the catch tab to the second position.

14. The multi-strike fastener driver/holder of claim 1 further comprising a return spring positioned between the frame and the anvil to bias the anvil in the opposite direction.

15. The multi-strike fastener driver/holder of claim 14 wherein the return spring is an elongate helical spring and the shaft has an elongate bore that receives a portion of the return spring.

16. The multi-strike fastener driver/holder of claim 15 wherein the frame comprises a spring guide received within a portion of the return spring.

17. The multi-strike fastener driver/holder of claim 1 wherein the feeder assembly comprises:
a fastener magazine configured to carry the plurality of fasteners; and
a fastening nozzle configured to sequentially receive individual fasteners from the fastener magazine and to sequentially position each fastener relative to the fastener drive assembly to be driven into a work surface by the fastener drive assembly.

18. The multi-strike fastener driver/holder of claim 17 wherein the anvil comprises a drive surface configured to strike a fastener positioned in the fastening nozzle to drive the fastener into a work surface, and the anvil is trapped between a portion of the frame and a portion of the fastening nozzle.

19. A multi-strike fastener driver/holder comprising:
a fastener drive assembly comprising:
a frame;
an anvil mounted in the frame to translate along a drive axis in an impact direction to drive a fastener into a work surface and to translate along the drive axis in an opposite direction to allow another fastener to be positioned for driving into a work surface, the anvil comprising an elongate shaft, a length of the shaft having a uniform transverse cross-section; and
a catch mounted in the frame to be actuated between a first condition and a second condition, in the first condition the catch allows translation of the anvil in the impact direction and restricts translation of the anvil in the opposite direction, in the second condition the catch allows translation of the anvil in the opposite direction, the catch comprising a catch tab having a pair of spaced surfaces that engage the elongate shaft with the catch in the first condition to restrict translation of the anvil in the opposite direction, the catch tab mounted in the frame to pivot between a first position wherein the catch is in the first condition and a second position wherein the catch is in the second condition, the spaced surfaces defining at least a portion of an opening that receives the elongate shaft; and
a feeder assembly fixed to the frame, the feeder assembly configured to carry a plurality of fasteners and to sequentially position each fastener of the plurality of fasteners relative to the fastener drive assembly to be driven by the fastener drive assembly into a work surface.

20. The multi-strike fastener driver/holder of claim 9 wherein the catch tab has an end portion located between the shaft and the frame, the frame has a slot that receives the end portion, and the catch further comprises at least one bias spring extending between the frame and the catch tab to bias the catch tab toward the first position.
